(19) United States
(12) Patent Application Publication
(10) Pub. No.: US 2025/0365160 A1
(43) Pub. Date: Nov. 27, 2025

(54) ELECTRONIC APPARATUS GENERATING CONTENT PROVENANCE INFORMATION, CONTROL METHOD FOR ELECTRONIC APPARATUS, AND STORAGE MEDIUM

(71) Applicant: CANON KABUSHIKI KAISHA, Tokyo (JP)

(72) Inventor: DAIYU UENO, Tokyo (JP)

(21) Appl. No.: 19/212,462

(22) Filed: May 19, 2025

(30) Foreign Application Priority Data
May 21, 2024 (JP) 2024-082458

(51) Int. Cl. H04L 9/32

(52) U.S. Cl. CPC H04L 9/3247; H04L 9/3239

(57) ABSTRACT

An electronic apparatus includes at least one memory and at least one processor. The at least one memory stores one or more programs that, when executed by the at least one processor, causes the at least one processor to generate content including a plurality of metadata items, select one or more metadata items from among the plurality of metadata items to be incorporated in provenance data, and generate the provenance data that incorporates the selected one or more metadata items and a hash value. The provenance data is generated when the content including the plurality of metadata items is generated.

### BACKGROUND

### Technical Field

The present disclosure relates to an electronic apparatus that generates content provenance information.

### Description of the Related Art

In recent years, information sharing through the Internet has been actively carried out, and everyone has been able to publish and deliver various kinds of information to an unspecified number of people. In addition, various kinds of digital image processing have become possible. In such circumstances, information may be delivered from unreliable sources and may have been fraudulently altered.

A technique has been known by which a hash value is generated from an image when the image is captured by a digital camera with an authenticity verification function enabled, the hash value is added to the image, and the hash value is used by a user of the image to verify the falsification of the image. See Japanese Patent Application Laid-open No. 2008-5421.

Adding, to an image, metadata indicating editing performed on the image to certificate the source, the history, and the provenance of the image is discussed, for example, in the Coalition for Content Provenance and Authenticity's (“C2PA”) “C2PA Technical Specification,” Version 1.2, at https://c2pa.org/specifications/specifications/1.2/specs/C2PA_Specification.html, released on Nov. 3, 2022 and found through an Internet search on Jan. 23, 2023.

Some images obtained by image capturing can include unwanted metadata. In this case, the metadata needs to be deleted later when the image is edited.

However, where the authenticity verification function is enabled in the apparatus described in Japanese Patent Application Laid-open No. 2008-5421, there is an issue that the hash value is changed and the image is treated as a falsified image when the unwanted metadata is deleted.

### SUMMARY

According to an aspect of the present disclosure, an electronic apparatus includes at least one memory storing one or more programs and at least one processor that, upon execution of the stored one or more programs, causes the at least one processor to generate a content including a plurality of metadata items, select one or more metadata items from among the plurality of metadata items to be incorporated in provenance data, and generate the provenance data that incorporates the selected one or more metadata items and a hash value wherein the provenance data is generated when the content including the plurality of metadata items is generated.

Further features of the present disclosure will become apparent from the following description of exemplary embodiments with reference to the attached drawings.

### BRIEF DESCRIPTION OF THE DRAWINGS

FIGS. 1A and 1B are perspective views respectively illustrating a front side appearance and a back side appearance of an image capturing apparatus according to a first exemplary embodiment.

FIG. 2 is a block diagram illustrating a configuration of the image capturing apparatus according to the first exemplary embodiment.

FIGS. 3A and 3B1-3B4 are flowcharts respectively illustrating main processing and setting processing according to the first exemplary embodiment.

FIG. 4 is a flowchart illustrating image capturing processing according to the first exemplary embodiment.

FIGS. 5A to 5E are diagrams each illustrating an example of a screen displayed on the image capturing apparatus according to the first exemplary embodiment.

FIGS. 6A and 6B are diagrams each illustrating an example of an image file configuration according to the first exemplary embodiment.

FIG. 7 is a flowchart illustrating reproduction processing according to the first exemplary embodiment.

### DESCRIPTION OF THE EMBODIMENTS

With reference to the attached drawings, exemplary embodiments of the present disclosure will be described in detail.

The exemplary embodiments described below are merely examples and may be modified and changed depending on the configuration of the apparatus to which the present disclosure is applied, or various kinds of conditions. Combining the exemplary embodiments is also possible.

With reference to the attached drawings, the exemplary embodiments of the present disclosure will be described. Now, a first exemplary embodiment will be described.

### Digital Camera

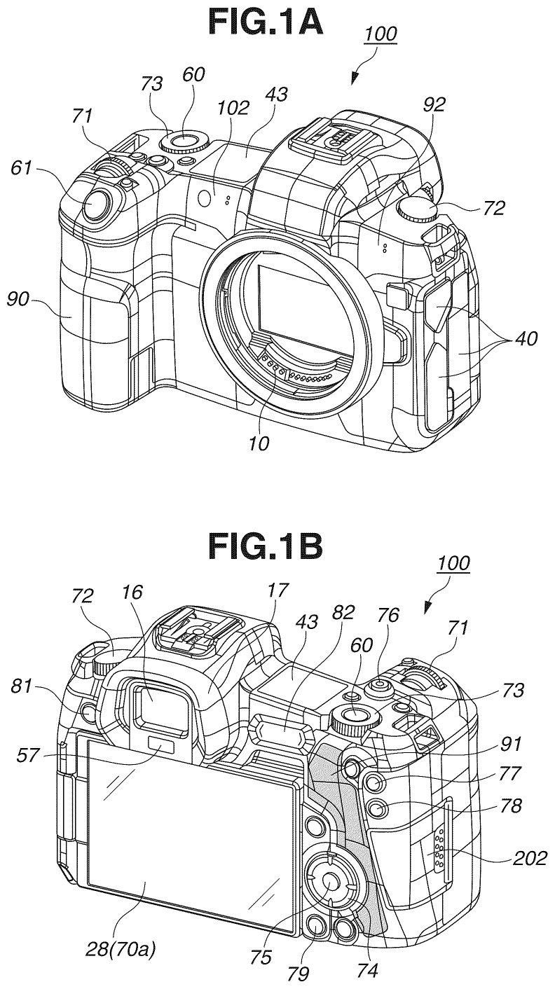

FIGS. 1A and 1B are diagrams of a digital camera (image capturing apparatus) 100 as an example of an apparatus to which the present disclosure is applicable. FIG. 1A is a front side perspective view of the digital camera 100, and FIG. 1B is a back side perspective view of the digital camera 100. In the present exemplary embodiment, the digital camera 100 is described as an example of an electronic apparatus, but the electronic apparatus is not limited to the digital camera 100. For example, the electronic apparatus may be a portable media player, or an information processing apparatus, such as a so-called tablet device, a smartphone, or a personal computer.

A display unit 28 is a display unit arranged on the back side of the digital camera 100 to display images or various kinds of information. A touch panel 70a can detect a touch operation on the display surface (touch operation surface) of the display unit 28. An out-of-viewfinder display unit 43 is a display unit provided on the upper surface of the digital camera 100 to display various setting values of the digital camera 100, such as a shutter speed or an aperture value. A shutter button 61 is an operation member for issuing an image capturing instruction. A mode selection switch 60 is an operation member for switching a mode between various modes.

Terminal covers 40 are covers for protecting connectors (not illustrated) for connection cables and the like to connect the digital camera 100 to an external apparatus.

A main electronic dial 71 is a rotational operation member, and the setting values such as a shutter speed and an aperture value can be changed by rotating the main electronic dial 71. A power switch 72 is an operation member for switching ON and OFF the power of the digital camera 100. A sub-electronic dial 73 is a rotational operation member, and selection frame (cursor) movement and image feeding can be performed by rotating the sub-electronic dial 73. A four-direction key 74 is configured in such a manner that upper, lower, right, and left portions thereof can be pressed, and processing corresponding to the pressed portion of the four-direction key 74 can be performed. A SET button 75 is a press button, and mainly used for selecting an item.

A moving image button 76 is used to issue an instruction to start or stop capturing (recording) a moving image. An automatic exposure (AE) lock button 77 is a press button, and an exposure state can be fixed by pressing the AE lock button 77 in an image capturing standby state. A zoom button 78 is an operation button for switching ON and OFF a zoom mode in a live view (LV) display while in an image capturing mode. By operating the main electronic dial 71 after turning on the zoom mode, an LV image can be enlarged or reduced in size. In a reproduction mode, the zoom button 78 functions as an operation button for enlarging the reproduced image and increasing the enlargement ratio. A reproduction button 79 is an operation button for switching a mode between the image capturing mode and the reproduction mode. When the reproduction button 79 is pressed while in the image capturing mode, the image capturing mode shifts to the reproduction mode, and a latest image from among images recorded in a recording medium 200 (described below) can be displayed on the display unit 28.

A menu button 81 is a press button used for performing an instruction operation to display a menu screen. When the menu button 81 is pressed, the menu screen on which various kinds of settings can be adjusted is displayed on the display unit 28. A user can instinctively adjust the various kinds of settings using the menu screen displayed on the display unit 28, the four-direction key 74, and the SET button 75.

A touch bar 82 (multifunction bar) is a linear touch operation member (line touch sensor) that can receive a touch operation. The touch bar 82 is arranged at a position at which a touch operation (touch) is possible with the right thumb in a state where a user holds a grip portion 90 with the user's right hand (i.e., with right little finger, right ring finger, and right middle finger) so as to be able to press the shutter button 61 with the user's right index finger. In other words, the touch bar 82 is arranged at a position at which the touch bar 82 is operable in a state where the user holds the digital camera 100 (image capturing posture) in such a manner that the user keeps the user's eye in contact with an eyepiece portion 16 to look into the viewfinder so as to be ready to press the shutter button 61 at any moment. The touch bar 82 is a reception unit that can receive a tap operation (operation to touch and release within a predetermined period without moving) or a right-and-left slide operation (operation to move the touched position while keeping the touched state, after touching) on the touch bar 82. The touch bar 82 is an operation member different from the touch panel 70a and includes no display function.

Communication terminals 10 are communication terminals for the digital camera 100 to communicate with a lens unit 150 (attachable and detachable) described below. The eyepiece portion 16 is an eyepiece portion of an eyepiece viewfinder 17 (look-in type viewfinder), and through the eyepiece portion 16, a user can visually recognize an image displayed on an electronic viewfinder (EVF) 29 arranged inside the digital camera 100. An eye proximity detection unit 57 is an eye proximity detection sensor for detecting whether a user's eye (photographer's eye) is placed close to the eyepiece portion 16. A cover 202 is a cover for a slot to store the recording medium 200 described below. The grip portion 90 is a holding portion with a shape to be easily gripped by a user with the user's right hand when the user holds the digital camera 100 to capture an image. The shutter button 61 and the main electronic dial 71 are arranged at positions at which the shutter button 61 and the main electronic dial 71 are operable with the user's right index finger, in a state where the user holds the grip portion 90 with the user's right little finger, right ring finger, and right middle finger. The sub-electronic dial 73 and the touch bar 82 are arranged at positions at which the sub-electronic dial 73 and the touch bar 82 are operable with the user's right thumb in the same state as that described above. A thumb rest portion 91 (thumb standby position) is a grip member arranged at a position at which the user's right thumb can be easily placed when the user holds the grip portion 90 in a state where the user does not operate any operation member on the back side of the digital camera 100. The thumb rest portion 91 is formed of a rubber material to increase a retention force (sense of gripping).

### Configuration Blocks of Digital Camera

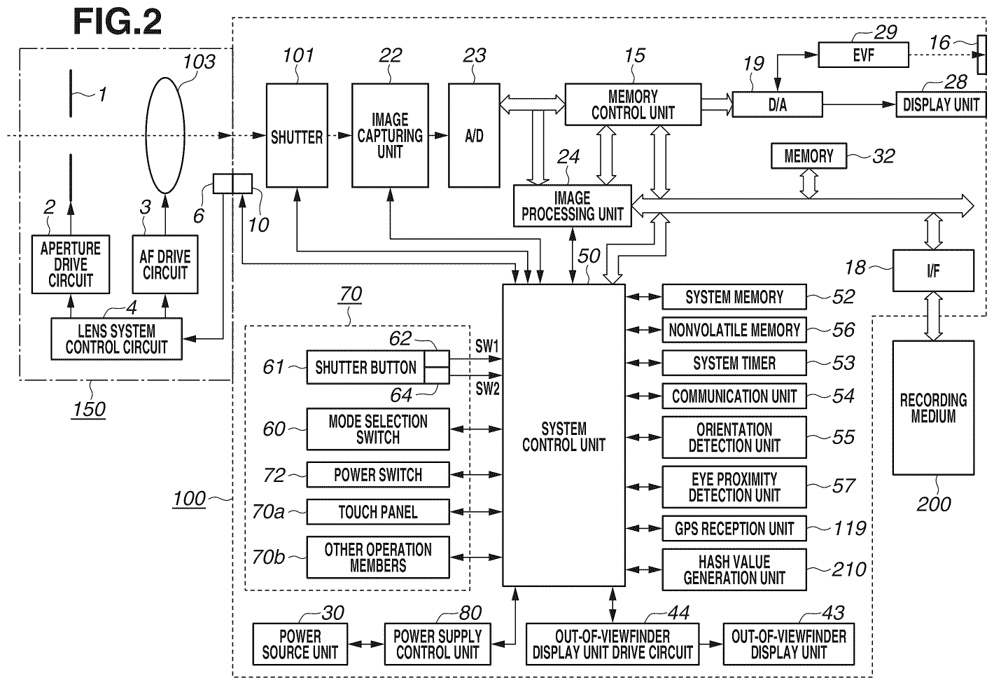

FIG. 2 is a block diagram illustrating an example of a configuration of the digital camera 100.

The lens unit 150 is an interchangeable lens unit including an imaging lens. A lens 103 is usually formed of a plurality of lenses but is formed of only one lens as illustrated in FIG. 2 for simplification. Communication terminals 6 are communication terminals for the lens unit 150 to communicate with the digital camera 100, and the communication terminals 10 are the communication terminals for the digital camera 100 to communicate with the lens unit 150. The lens unit 150 communicates with a system control unit 50 through the communication terminals 6 and 10. In the lens unit 150, a lens system control circuit 4 controls an aperture 1 via an aperture drive circuit 2. The lens unit 150 performs focusing by displacing the position of the lens 103 by the lens system control circuit 4 via an autofocus (AF) drive circuit 3.

A shutter 101 is a focal plane shutter that can arbitrarily control an exposure time of an image capturing unit 22 under control of the system control unit 50.

The image capturing unit 22 is an image capturing device (image sensor) consisting of a charge-coupled device (CCD) sensor, a complementary metal-oxide semiconductor (CMOS) sensor, or the like, that converts an optical image into an electrical signal. The image capturing unit 22 may include an imaging plane phase difference sensor for outputting defocus amount information to the system control unit 50. An analog-to-digital (A/D) converter 23 converts an analog signal output from the image capturing unit 22 into a digital signal.

An image processing unit 24 performs predetermined processing (e.g., pixel interpolation, resize processing such as size reduction, color conversion processing, or the like) on data output from the A/D converter 23 or data output from a memory control unit 15. The image processing unit 24 performs predetermined calculation processing using captured image data, and the system control unit 50 performs an exposure control and a ranging control based on the calculation result obtained by the image processing unit 24. In this way, through-the-lens (TTL) AF processing, autoexposure (AE) processing, electronic flash pre-emission (EF) processing, and the like are performed. Further, the image processing unit 24 performs predetermined calculation processing using the captured image data and performs TTL automatic white balance (AWB) processing based on the obtained calculation result.

The output data from the A/D converter 23 is written to a memory 32 via the image processing unit 24 and the memory control unit 15. Alternatively, the output data from the A/D converter 23 is written to the memory 32 via the memory control unit 15, not via the image processing unit 24. The memory 32 stores the image data obtained by the image capturing unit 22 and converted by the A/D converter 23 into digital data, and the image data to be displayed on the display unit 28 or the EVF 29. The memory 32 has enough memory capacity for storing a predetermined number of still images or a predetermined time period of a moving image and sounds.

The memory 32 also serves as an image display memory (video memory). A digital-to-analog (D/A) converter 19 converts the data for image display stored in the memory 32 into an analog signal and supplies the analog signal to the display unit 28 or the EVF 29. In this way, the image data to be displayed written into the memory 32 is displayed on the display unit 28 or the EVF 29 via the D/A converter 19. Each of the display unit 28 and the EVF 29 is a display such as a liquid crystal display (LCD), an organic electroluminescence (EL) display, or the like, and performs display according to the analog signal input from the D/A converter 19. The digital signal that is A/D converted by the A/D converter 23 and stored in the memory 32 is converted into the analog signal by the D/A converter 19, and the analog signal is sequentially transferred to and displayed on the display unit 28 or the EVF 29 so that a live view (LV) display can be achieved. Hereinbelow, the image displayed in live view is referred to as a live view (LV) image.

The system control unit 50 is a control unit consisting of at least one processor and/or at least one circuit and controls the entire digital camera 100. The system control unit 50 executes programs stored in a nonvolatile memory 56 to implement various kinds of processing described below according to the present exemplary embodiment. The system control unit 50 controls the memory 32, the D/A converter 19, the display unit 28, the EVF 29, and so forth, to also perform display control.

A system memory 52 is, for example, a random access memory (RAM), and the system control unit 50 loads into the system memory 52 constants and variables for operating the system control unit 50, programs read from the nonvolatile memory 56, and so on.

The nonvolatile memory 56 is an electrically erasable/recordable memory, and is, for example, an electrically erasable programmable read only memory (EEPROM), or the like. The nonvolatile memory 56 stores constants, programs, and the like for operating the system control unit 50. The programs are programs for executing various kinds of processes described below in the present exemplary embodiment.

A system timer 53 is a time measurement unit for measuring time used for various kinds of controls and time of a built-in clock.

A communication unit 54 transmits and receives image signals and sound signals to and from an external apparatus connected wirelessly or through a wired cable. The communication unit 54 can connect to a wireless local area network (LAN) or the Internet. The communication unit 54 can communicate with the external apparatus through Bluetooth® or Bluetooth® Low Energy. The communication unit 54 can transmit an image (including LV image) captured by the image capturing unit 22 or an image recorded in the recording medium 200 to the external apparatus and can receive various kinds of information such as image data, a moving image recording start instruction and so forth from the external apparatus. When the communication unit 54 receives the moving image recording start instruction from the external apparatus, it is possible to notify a user that the instruction is received, by lighting a light emission device 102 or emitting an electronic sound from a speaker 92. Examples of the external apparatus to communicate with include a smartphone, a tablet personal computer (PC), a desktop PC, and so on.

An orientation detection unit 55 detects the orientation of the digital camera 100 with respect to the gravitational direction. Based on the orientation detected by the orientation detection unit 55, it can be determined whether the image captured by the image capturing unit 22 is captured by the digital camera 100 held in a horizontal direction (landscape mode) or in a vertical direction (portrait mode). The system control unit 50 can add direction information corresponding to the orientation detected by the orientation detection unit 55 to the image file of the image captured by the image capturing unit 22 or record the image in a rotated manner. The orientation detection unit 55 may be an acceleration sensor, a gyroscope sensor, or the like. It is also possible to detect the movement (panning, tilting, lifting, remaining still or the like) of the digital camera 100 using the acceleration sensor or the gyroscope sensor serving as the orientation detection unit 55.

The eye proximity detection unit 57 is an eye proximity detection sensor for detecting a proximity (eye proximity) of an eye (object) and a withdrawal (eye withdrawal) of an eye, to and from the eyepiece portion 16 of the eyepiece viewfinder (hereinbelow, referred to as viewfinder) 17. The system control unit 50 switches the display unit 28 and the EVF 29 between the display (display state) and the non-display (non-display state) based on the state detected by the eye proximity detection unit 57. More specifically, in a case where at least the digital camera 100 is in an image capturing standby state and a switching setting of the display destination is an automatic switching, the display of the display unit 28 is turned ON as a display destination, and the display of the EVF 29 is turned OFF, when the user's eye is far from the eyepiece portion 16. When the user's eye is placed in proximity of the eyepiece portion 16, the display of the EVF 29 is turned ON as a display destination, and the display of the display unit 28 is set to a non-display state. For example, an infrared proximity sensor can be used as the eye proximity detection unit 57 and can detect the proximity of a certain object to the eyepiece portion 16 of the viewfinder 17 with the EVF 29 built therein. In a case where an object has approached the eyepiece portion 16, the infrared beam emitted from an infrared light emitting unit (not illustrated) of the eye proximity detection unit 57 is reflected from the object and received by a light receiving unit (not illustrated) of the eye proximity detection unit 57. It is possible to determine how close the object is (distance from the object) to the eyepiece portion 16 based on the received infrared light amount. In this way, the eye proximity detection unit 57 can detect the proximity of the object to the eyepiece portion 16. In a case where a user's eye approaching the eyepiece portion 16 within a predetermined distance from the eye withdrawal state (non-proximity state) is detected, the user's eye is detected to be in contact with the eyepiece portion 16. In a case where a user's eye detected to be in contact with the eyepiece portion 16 separates by more than a predetermined distance from the eye contact state (proximity state), the user's eye is detected to be withdrawn from the eyepiece portion 16. The threshold value for detecting eye proximity and the threshold value for detecting eye withdrawal may be set differently by providing a hysteresis. After detecting the eye contact state (proximity state), the state continues to be determined as the eye contact state (proximity state) until the withdrawal of the user's eye is detected. After detecting the eye withdrawal state (non-proximity state), the state continues to be determined as the eye withdrawal state (non-proximity state) until the proximity of the user's eye is detected. The infrared proximity sensor is just an example, and another sensor may be employed as the eye proximity detection unit 57 as long as the sensor can detect a state that can be considered as the eye contact state (proximity state).

A global positioning system (GPS) reception unit 119 receives GPS information for calculating location information and time information from a GPS satellite. The digital camera 100 receives the GPS information with the GPS reception unit 119 and calculates the location information and the time information based on the received GPS information. The digital camera 100 can add the calculated location information and time information to the image file of the image captured by the image capturing unit 22.

A hash value generation unit 210 executes a hash function on an image file to generate (calculate) a hash value. Instead of the hash value generation unit 210, the system control unit 50 may generate the hash value. Details of the hash value generation processing will be described below.

The out-of-viewfinder display unit 43 displays, via an out-of-viewfinder display unit drive circuit 44, various kinds of setting values for the digital camera 100, including a shutter speed or an aperture value.

A power supply control unit 80 includes a battery detection circuit, a direct- current to direct-current (DC-DC) converter, a switching circuit for switching blocks to be energized, and the like, and detects whether the battery is attached or detached, a type of the battery, a remaining amount of the battery, and the like. The power supply control unit 80 controls the DC-DC converter based on the battery detection result and an instruction from the system control unit 50 to supply a required voltage during a required period to each of all the units within the digital camera 100, as shown in FIG. 2, such as the memory control unit 15, the image processing unit 24, the display unit 28, the memory 32, the system control unit 50, and so on, including the recording medium 200. A power source unit 30 may include one or more of a variety of power sources, including a primary battery such as an alkaline battery, a lithium (Li) battery, or the like, a secondary battery such as a nickel-cadmium (NiCd) battery, a nickel-metal hydride (NiMH) battery, a lithium (Li) battery, or the like, an alternate current (AC) adapter, and so on.

A recording medium interface (I/F) 18 is an interface with the recording medium 200. The recording medium 200 is a medium for recording captured images, such as a memory card, a hard disk, or the like, and may include a semiconductor memory, a magnetic disk, or the like.

An operation unit 70 is an input unit for receiving an operation from a user (user operation) and used for inputting various kinds of operation instructions to the system control unit 50. As illustrated in FIG. 2, the operation unit 70 includes the shutter button 61, the mode selection switch 60, the power switch 72, the touch panel 70a, other operation members 70b, and so on. The other operation members 70b include the main electronic dial 71, the sub-electronic dial 73, the four-direction key 74, the SET button 75, the moving image button 76, the AE lock button 77, the zoom button 78, the reproduction button 79, the menu button 81, the touch bar 82, and the like.

The shutter button 61 is provided with a first shutter switch 62 and a second shutter switch 64. The first shutter switch 62 turns ON when the shutter button 61 is operated halfway, so-called half-pressed (image capturing preparation instruction), and generates a first shutter switch signal SW1. In response to the first shutter switch signal SW1, the system control unit 50 starts an image capturing preparation operation such as the AF processing, the AE processing, the AWB processing, the EF processing, and so on.

The second shutter switch 64 turns ON when the operation of the shutter button 61 is completed, so-called fully pressed (image capturing instruction), and generates a second shutter switch signal SW2. In response to the second shutter switch signal SW2, the system control unit 50 starts a series of image capturing operations, from an operation of reading a signal from the image capturing unit 22 to an operation of writing the captured image into the recording medium 200 as an image file.

The mode selection switch 60 switches the operation mode of the system control unit 50 to any one of a still image capturing mode, a moving image capturing mode, a reproduction mode, and so forth. The still image capturing mode may include one or more of an automatic image capturing mode, an automatic scene determination mode, a manual mode, an aperture priority mode (Av mode), a shutter speed priority mode (Tv mode), and/or a program AE mode (P mode). These modes may further include various scene modes each serving as an image capturing mode for a scene, a custom mode, and so on. A user can directly switch the mode to any one of these modes by the mode selection switch 60. Alternatively, after a screen is switched to a menu screen listing the image capturing modes by the mode selection switch 60, the mode may be selectively switched to any one of the plurality of displayed modes using another operation member. Similarly, the moving image capturing mode may include a plurality of modes.

The touch panel 70a is a touch sensor for detecting various kinds of touch operations on the display surface of the display unit 28 (operation surface of the touch panel 70a). The touch panel 70a and the display unit 28 can be integrally formed. For example, the touch panel 70a is configured to have a light transmittance not to interrupt the display of the display unit 28 and attached to an upper layer of the display surface of the display unit 28. Input coordinates on the touch panel 70a and display coordinates on the display surface of the display unit 28 are associated with each other. In this way, a graphical user interface (GUI) can be provided to allow a user to directly operate the screen displayed on the display unit 28.

The system control unit 50 can detect the following operations or states on the touch panel 70a.
Touch-down: a state where the touch panel 70a is newly touched by a finger (fingers) or a pen after not having touched the touch panel 70a, i.e., start of touch.
Touch-on: a state where the touch panel 70a is being touched by a finger (fingers) or a pen.
Touch-move: a state where a finger (fingers) or a pen is moving while the finger (fingers) or the pen continues touching the touch panel 70a.
Touch-up: a state where a finger (fingers) or a pen touching the touch panel 70a is separated (released) from the touch panel 70a, i.e., end of touch.
Touch-off: a state where neither a finger (fingers) nor a pen is touching the touch panel 70a.

When a touch-down is detected, a touch-on is also detected at the same time. After the touch-down, normally the touch-on continues to be detected as long as a touch-up is not detected. In a case where a touch-move is detected, a touch-on is also detected at the same time. Even when the touch-on is detected, the touch-move is not detected when the touch position does not move. After the touch-up of all the fingers or the pen touching the touch panel 70a is detected, the state becomes a touch-off.

The system control unit 50 is notified of these operations, states, and position coordinates on the touch panel 70a at which the finger (fingers) or the pen is touching, through an internal bus. The system control unit 50 determines which operation (touch operation) is performed on the touch panel 70a based on the provided information. Regarding the touch-move state, the directions of the finger (fingers) or the pen moving on the touch panel 70a can be determined for each of the vertical component and the horizontal component on the touch panel 70a based on the change of the position coordinates. When a predetermined distance or more of a touch-move is detected, the system control unit 50 determines that a slide operation is performed. Quickly swiping or moving a finger for a certain distance while touching the touch panel 70a, and then separating the finger therefrom is referred to as a flick.

When a touch-move for a predetermined distance or more at a predetermined speed or more is detected, and then a touch-up is detected, the system control unit 50 can determine that a flick is performed. Further, when a user touches a plurality of positions (e.g., two points) on the touch panel 70a at a time (multi-touch) with the user's fingers, a touch-move operation of bringing the two points closer to each other is referred to as a pinch-in, and a touch-move operation of bringing the two points away from each other is referred to as a pinch-out. The pinch-out and the pinch-in are collectively referred to as a pinch-operation, or simply as a pinch. The touch panel 70a may be implemented via any method from among various touch panel methods, such as a resistance film method, an electrostatic capacitance method, a surface elastic wave method, an infrared light method, an electromagnetic induction method, an image recognition method, an optical sensor method, and so forth. There are methods of detecting a touch when a finger (fingers) or a pen contacts the touch panel 70a, and methods of detecting a touch when a finger (fingers) or a pen is brought close to the touch panel 70a, and any of the methods may be employed.

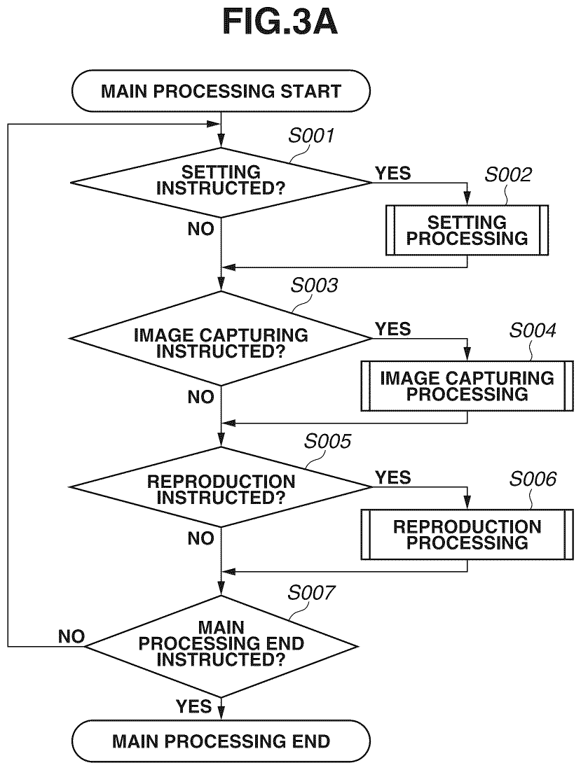

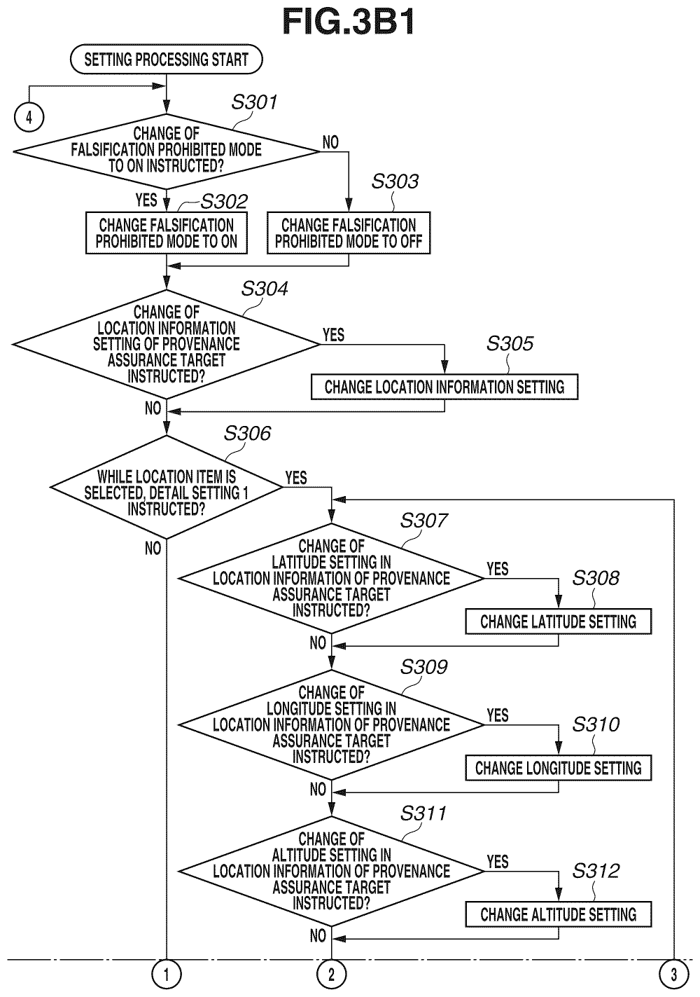

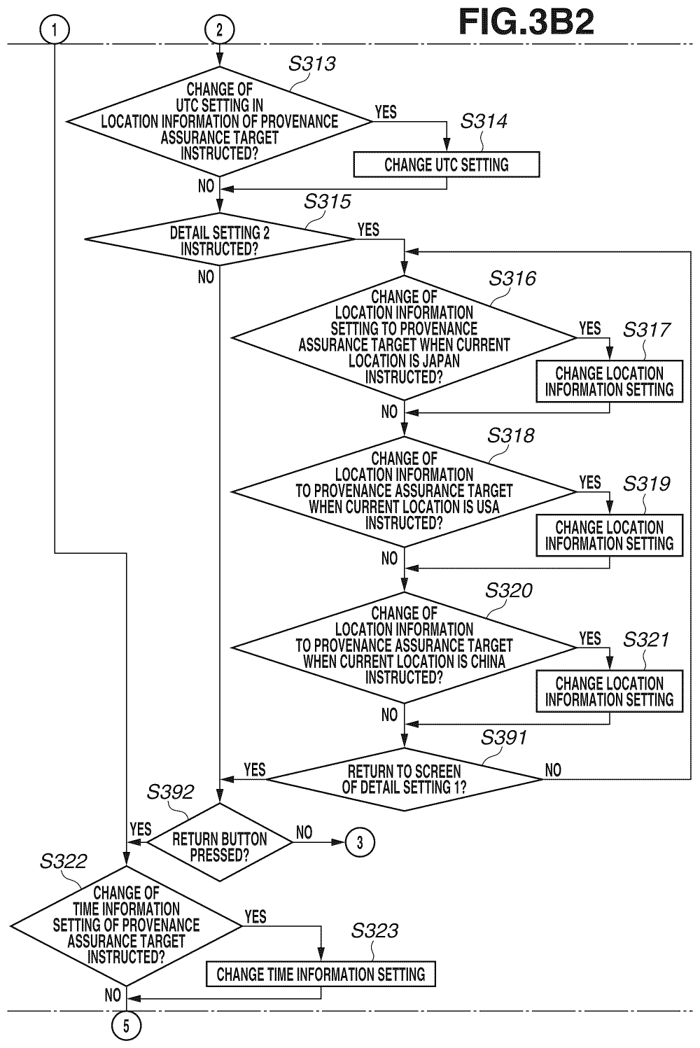

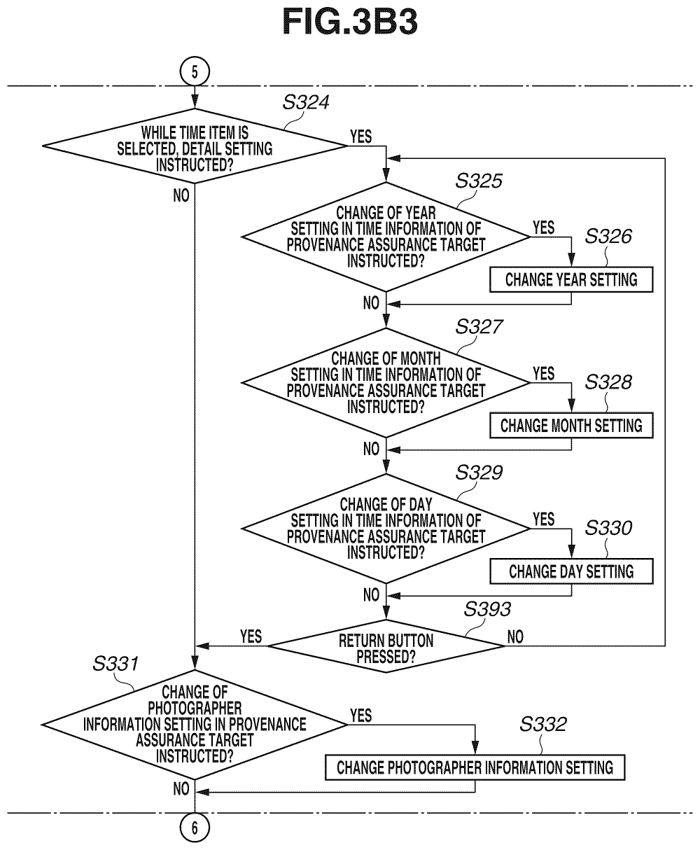

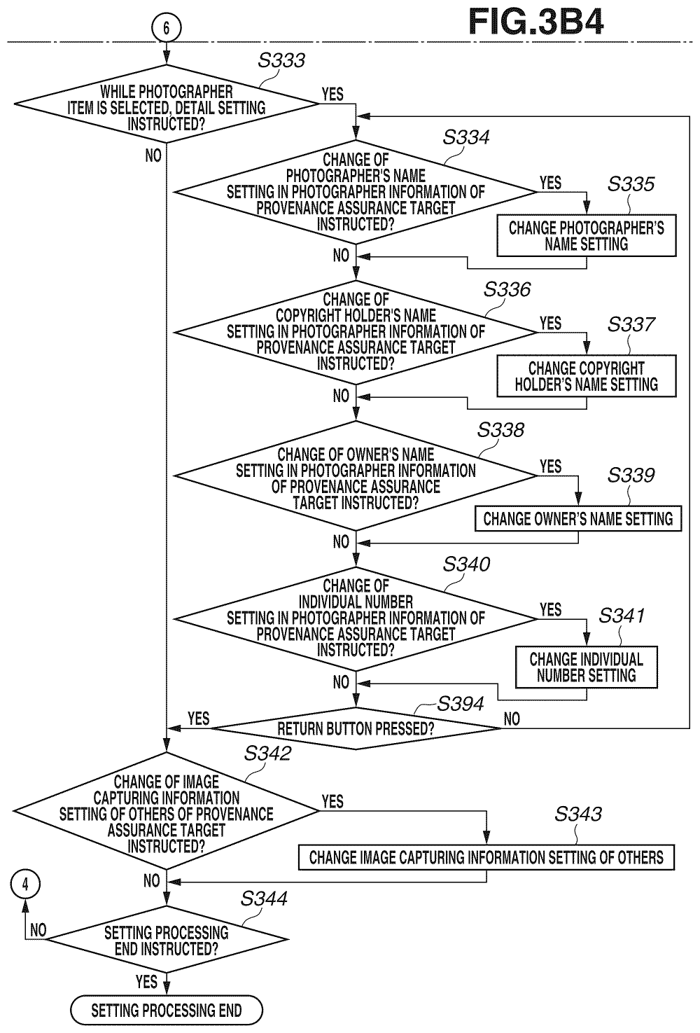

FIG. 3A is a flowchart illustrating main processing according to the present exemplary embodiment. This flowchart is implemented by the system control unit 50 loading a program stored in the nonvolatile memory 56 into the system memory 52, and executing it, in response to a turning ON of the power switch 72.

In step S001, the system control unit 50 determines whether a user issues an instruction to start setting processing. The user can perform an operation on the operation unit 70 or on a menu to input the instruction to start the setting processing. In a case where the system control unit 50 determines that the user issues the instruction to start the setting processing (YES in step S001), the processing proceeds to step S002. In step S002, the system control unit 50 performs the setting processing. The setting processing will be described below. In a case where the system control unit 50 determines that the user does not issue the instruction to start the setting processing (NO in step S001), the processing proceeds to step S003.

In step S003, the system control unit 50 determines whether the user issues an instruction to start image capturing processing. The user can press the shutter button 61 or the like to input the instruction to start the image capturing processing. In a case where the system control unit 50 determines that the user issues the instruction to start the image capturing processing (YES in step S003), the processing proceeds to step S004. In step S004, the system control unit 50 performs the image capturing processing. The image capturing processing will be described below. In a case where the system control unit 50 determines that the user does not issue the instruction to start the image capturing processing (NO in step S003), the processing proceeds to step S005.

In step S005, the system control unit 50 determines whether the user issues an instruction to start reproduction processing. The user can press the reproduction button 79 to input the instruction to start the reproduction processing. In a case where the system control unit 50 determines that the user issues the instruction to start the reproduction processing (YES in step S005), the processing proceeds to step S006. In step S006, the system control unit 50 performs the reproduction processing. The reproduction processing will be described below. In a case where the system control unit 50 determines that the user does not issue the instruction to start the reproduction processing (NO in step S005), the processing proceeds to step S007.

In step S007, the system control unit 50 determines whether the user issues an instruction to end the main processing. The user can operate the power switch 72 or the like to input the instruction to end the main processing. In a case where the system control unit 50 determines that the user issues the instruction to end the main processing (YES in step S007), the system control unit 50 ends the main processing. In a case where the system control unit 50 determines that the user does not issue the instruction to end the main processing (NO in step S007), the processing returns to step S001.

The setting processing performed in step S002 in FIG. 3A will be described. FIGS. 3B1 to 3B4 are a flowchart illustrating the setting processing according to the present exemplary embodiment.

In step S301, the system control unit 50 determines whether the user issues a setting instruction to set a falsification prohibited mode to ON. The user can perform an operation on the menu screen to input the setting instruction to set the falsification prohibited mode to ON.

In a case where the user issues the setting instruction to set the falsification prohibited mode to ON (YES in step S301), the processing proceeds to step S302. In a case where the user issues the setting instruction to set the falsification prohibited mode to OFF (NO in step S301), the processing proceeds to step S303. In a state where the falsification prohibited mode is ON, provenance information 603 (described below) is incorporated in an image obtained by the image capturing. In a state where the falsification prohibited mode is OFF, the provenance information 603 is not incorporated in the image obtained by the image capturing. The provenance information 603 is used to detect the change of the image using a hash system or a signature value system described below.

In step S302, the system control unit 50 changes the setting of the falsification prohibited mode to ON and stores the changed setting in the memory 32. In a case where the setting of the falsification prohibited mode is already ON, the processing in step S302 is skipped.

In step S303, the system control unit 50 changes the setting of the falsification prohibited mode to OFF and stores the changed setting in the memory 32. In a case where the setting of the falsification prohibited mode is already OFF, the processing in step S303 is skipped.

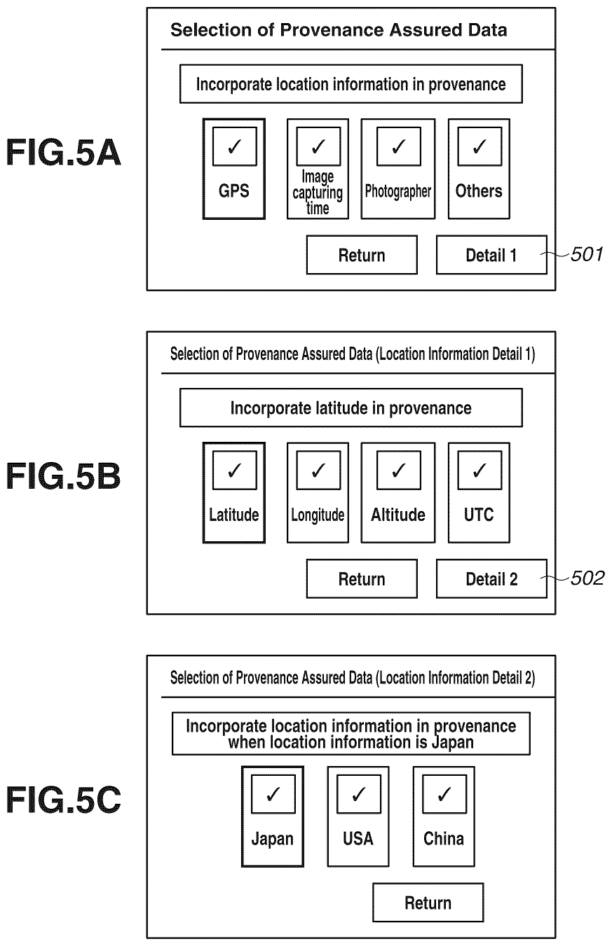

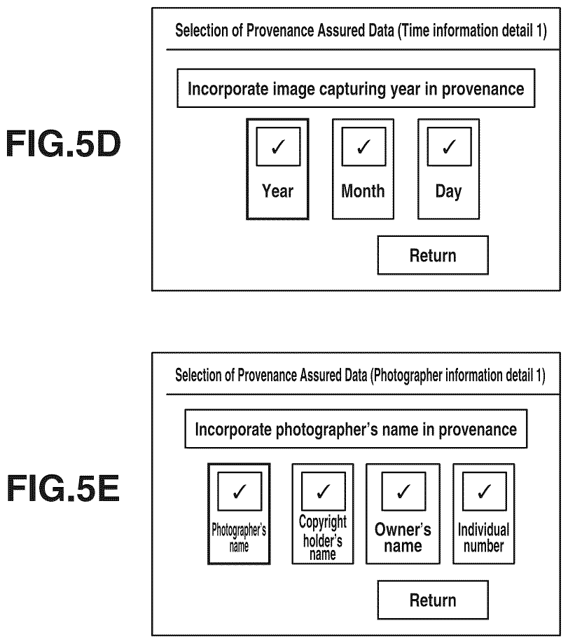

In step S304, the system control unit 50 determines whether the user issues a setting change instruction of whether to incorporate location information data in a provenance assurance target. In a case where the user issues the setting change instruction of whether to incorporate the location information data in the provenance assurance target (YES in step S304), the processing proceeds to step S305. Otherwise (NO in step S304), the processing proceeds to step S306. The user can perform an operation on the menu screen to input the setting change instruction of whether to incorporate the location information data in the provenance assurance target. FIG. 5A illustrates an example of the menu screen displayed at this time. The menu screen in FIG. 5A may be displayed in parallel with or after the processing in step S302, in response to, for example, the determination that the setting instruction to set the falsification prohibited mode to ON is input through the operation on the menu screen in step S301. The example in FIG. 5A illustrates a state where a location item (item described as GPS) is the focus of the setting processing. As the frame surrounding the location item is displayed thicker than the frames surrounding the other items, the user can understand that the location item is the focus of the setting processing.

In the example of FIG. 5A, the menu screen is displayed in an initial state where all of the location information, the time information, the photographer information, and the other information are set to be incorporated in the provenance assurance target as indicated by each check box being checked. The user can select an item with its check box checked to uncheck the check box for that item. The user can set the checked items to be incorporated in the provenance assurance target and unchecked items to be excluded from the provenance assurance target by checking or unchecking the check boxes for the corresponding displayed items. In step S304, in a case where the GPS item in FIG. 5A is selected to change the state from the unchecked state to the checked state, the system control unit 50 determines that the user issues the setting change instruction to incorporate the location information data in the provenance assurance target. In a case where the GPS item is selected to change the state from the checked state to the unchecked state, the system control unit 50 determines that the user issues the setting change instruction to exclude the location information data from the provenance assurance target. In similar user interfaces other than the interface displayed in FIG. 5A, the operation of checking or unchecking a box is received as an instruction to change the setting.

The location information, the time information, and the photographer information are exemplified because there may be a high possibility that a user would not want such information to be released to the public, but the information is not limited to these types of information. Regarding data other than those described above, in a case where the user does not want the user's image capturing technique to be known, for example, the user may not want the corresponding settings to be known to others. Thus, selectable data other than the location, the time, and the photographer can be employed as the data the user does not want to release to the public.

In step S305, the system control unit 50 changes the setting of whether to incorporate the location information data in the provenance assurance target in response to the received operation and stores the changed setting in the memory 32. Since the check box format is employed in the present exemplary embodiment, it is assumed that ON and OFF are switched, but the user may explicitly designate ON or OFF.

In step S306, the system control unit 50 determines whether the user issues a change instruction to display a first detail setting screen for the location information data selected for incorporation in the provenance assurance target. The user can perform an operation on the menu screen to input the change instruction for displaying the first detail setting screen for the location information data selected for incorporation in the provenance assurance target. In the example of FIG. 5A, a “Detail 1” button 501 is displayed. In a case where the user selects the “Detail 1” button 501 in a state where the location item is the focus of the setting processing, the system control unit 50 determines that the change instruction for displaying the first detail setting screen for the location information data with its provenance to be assured is received. In a case where the user issues the change instruction for displaying the first detail setting screen for the location information data with its provenance to be assured (YES in step S306), for example, a screen in FIG. 5B is displayed, and the processing proceeds to step S307. Otherwise (NO in step S306), the processing proceeds to step S322 without displaying, for example, the screen in FIG. 5B. In the example of FIG. 5B, whether the latitude, the longitude, the altitude, or the Universal time coordinated (UTC) described below are to be incorporated in the provenance assurance target as the location information is settable.

In step S307, with reference to the example in FIG. 5B, the system control unit 50 determines whether the user issues a setting change instruction of whether to incorporate the latitude in the location information data selected for incorporation in the provenance assurance target. In a case where the user issues the setting change instruction of whether to incorporate the latitude data in the location information data selected for incorporation in the provenance assurance target (YES in step S307), the processing proceeds to step S308. Otherwise (NO in step S307), the processing proceeds to step S309.

In step S308, the system control unit 50 changes the setting of whether to incorporate the latitude data in the location information data selected for incorporation in the provenance assurance target and stores the changed setting in the memory 32. In this case, it is assumed that ON and OFF are switched, but the user may explicitly designate ON or OFF.

In step S309, the system control unit 50 determines whether the user issues a setting change instruction of whether to incorporate the longitude in the location information data selected for incorporation in the provenance assurance target. In a case where the user issues the setting change instruction of whether to incorporate the longitude data in the location information data selected for incorporation in the provenance assurance target (YES in step S309), the processing proceeds to step S310. Otherwise (NO in step S309), the processing proceeds to step S311.

In step S310, the system control unit 50 changes the setting of whether to incorporate the longitude data in the location information data selected for incorporation in the provenance assurance target and stores the changed setting in the memory 32.

In step S311, the system control unit 50 determines whether the user issues a setting change instruction of whether to incorporate the altitude in the location information data selected for incorporation in the provenance assurance target. In a case where the user issues the setting change instruction of whether to incorporate the altitude data in the location information data selected for incorporation in the provenance assurance target (YES in step S311), the processing proceeds to step S312. Otherwise (NO in step S311), the processing proceeds to step S313.

In step S312, the system control unit 50 changes the setting of whether to incorporate the altitude data in t the location information data selected for incorporation in the provenance assurance target and stores the changed setting in the memory 32.

In step S313, the system control unit 50 determines whether the user issues a setting change instruction of whether to incorporate the UTC data in the location information data selected for incorporation in the provenance assurance target. In a case where the user issues the setting change instruction of whether to incorporate the UTC data in the location information data selected for incorporation in the provenance assurance target (YES in step S313), the processing proceeds to step S314. Otherwise (NO in step S313), the processing proceeds to step S315.

In step S314, the system control unit 50 changes the setting of whether to incorporate the UTC data in t the location information data selected for incorporation in the provenance assurance target and stores the changed setting in the memory 32.

In step S315, the system control unit 50 determines whether the user issues a change instruction to display a second detail setting screen for the location information data selected for incorporation in the provenance assurance target. The user can perform an operation on the menu screen to input the change instruction for displaying the second detail setting screen for the location information data selected for incorporation in the provenance assurance target. In the example of FIG. 5B, a “Detail 2” button 502 is displayed. In a case where the user selects the “Detail 2” button 502, the system control unit 50 determines that the change instruction for displaying the second detail setting screen for the location information data selected for incorporation in the provenance assurance target is received. In a case where the user issues the change instruction for displaying the second detail setting screen for the location information data selected for incorporation in the provenance assurance target (YES in step S315), the system control unit 50 displays the screen in FIG. 5C, for example, and the processing proceeds to step S316. Otherwise (NO in step S315), the processing proceeds to step S392. In the example of FIG. 5C, the screen indicating whether to incorporate the location information in the provenance assurance target can be changed depending on the image capturing region.

In step S316, the system control unit 50 determines whether the user issues a setting change instruction of whether to incorporate the location information in the provenance assurance target when the current location is Japan. In a case where the user issues the setting change instruction of whether to incorporate the location information in the provenance assurance target when the current location is Japan (YES in step S316), the processing proceeds to step S317. Otherwise (NO in step S316), the processing proceeds to step S318.

In step S317, the system control unit 50 changes the setting of whether to incorporate the location information in the provenance assurance target when the current location is Japan and stores the changed setting in the memory 32. In this case, it is assumed that ON and OFF are switched, but the user may explicitly designate ON or OFF.

In step S318, the system control unit 50 determines whether the user issues a setting change instruction of whether to incorporate the location information in the provenance assurance target when the current location is the United States of America (USA). In a case where the user issues the setting change instruction of whether to incorporate the location information in the provenance assurance target when the current location is the USA (YES in step S318), the processing proceeds to step S319. Otherwise (NO in step S318), the processing proceeds to step S320.

In step S319, the system control unit 50 changes the setting of whether to incorporate the location information in the provenance assurance target when the current location is the USA and stores the changed setting in the memory 32.

In step S320, the system control unit 50 determines whether the user issues the setting change instruction of whether to incorporate the location information in the provenance assurance target when the current location is China. In a case where the user issues the setting change instruction of whether to incorporate the location information in the provenance assurance target when the current location is China (YES in step S320), the processing proceeds to step S321. Otherwise (NO in step S320), the processing proceeds to step S391.

In step S321, the system control unit 50 changes the setting of whether to incorporate the location information in the provenance assurance target when the current location is China and stores the changed setting in the memory 32.

In step S391, the system control unit 50 determines whether the user issues an instruction to return the screen from the second detail setting screen (screen in FIG. 5C) for the location information to the first detail setting screen (screen in FIG. 5B) for the location information. The user can input the instruction to return the screen from the second detail setting screen for the location information to the first detail setting screen for the location information by selecting, for example, a “Return” button as shown in FIG. 5C. In a case where the system control unit 50 determines that the instruction to return the screen to the first detail screen for the location information is not received (NO in step S391), the processing returns to step S316. In a case where the system control unit 50 determines that the instruction to return the screen to the first detail setting screen for the location information is received (YES in step S391), the processing proceeds to step S392.

In step S392, the system control unit 50 determines whether the user issues an instruction to return the screen from the first detail setting screen (screen in FIG. 5B) for the location information to the screen (screen in FIG. 5A) for selecting the provenance assurance target data. The user can input the instruction to return the screen from the first detail setting screen for the location information to the screen for selecting the provenance assurance target data by selecting, for example, a “Return” button as shown in FIG. 5B. In a case where the system control unit 50 determines that the instruction to return the screen to the screen for selecting the provenance assurance target data is not received (NO in step S392), the processing returns to step S307. In a case where the system control unit 50 determines that the instruction to return the screen to the screen for selecting the provenance assurance target data is received (YES in step S392), the processing proceeds to step S322.

In step S322, the system control unit 50 determines whether the user issues a setting change instruction of whether to incorporate time information data in the provenance assurance target. In a case where the user issues the setting change instruction of whether to incorporate the time information data in the provenance assurance target (YES in step S322), the processing proceeds to step S323. Otherwise (NO in step S322), the processing proceeds to step S324.

In step S323, the system control unit 50 changes the setting of whether to incorporate the time information data in the provenance assurance target and stores the changed setting in the memory 32.

In step S324, the system control unit 50 determines whether the user issues a change instruction to display a detail setting screen for the time information data with its provenance to be assured. The user can perform an operation on the menu screen to input the change instruction for displaying the detail setting screen for the time information data with its provenance to be assured. In the example of FIG. 5A, the “Detail 1” button 501 is displayed. In a case where the user selects the “Detail 1” button 501 in a state where a time item (item labeled “Image capturing time”) is the focus of the setting processing, the system control unit 50 determines that the change instruction for displaying the detail setting screen for the time information data with its provenance to be assured is received. In a case where the user issues the change instruction for displaying the detail setting screen for the time information data with its provenance to be assured (YES in step S324), the system control unit 50 displays, for example, the screen in FIG. 5D, and the processing proceeds to step S325. Otherwise (NO in step S324), the processing proceeds to step S331.

In step S325, the system control unit 50 determines whether the user issues a setting change instruction of whether to incorporate year data in the time information with its provenance to be assured. In a case where the user issues the setting change instruction of whether to incorporate the year data in the provenance assurance target (YES in step S325), the processing proceeds to step S326. Otherwise (NO in step S325), the processing proceeds to step S327.

In step S326, the system control unit 50 changes the setting of whether to incorporate the year data in the time information data with its provenance to be assured and stores the changed setting in the memory 32. In this case, it is assumed that ON and OFF are switched, but the user may explicitly designate ON or OFF.

In step S327, the system control unit 50 determines whether the user issues a setting change instruction of whether to incorporate month data in the time information with its provenance to be assured. In a case where the user issues the setting change instruction of whether to incorporate the month data in the time information with its provenance to be assured (YES in step S327), the processing proceeds to step S328. Otherwise (NO in step S327), the processing proceeds to step S329.

In step S328, the system control unit 50 changes the setting of whether to incorporate the month data in the time information with its provenance to be assured and stores the changed setting in the memory 32.

In step S329, the system control unit 50 determines whether the user issues a setting change instruction of whether to incorporate day data in the time information with its provenance to be assured. In a case where the user issues the setting change instruction of whether to incorporate the day data in the time information with its provenance to be assured (YES in step S329), the processing proceeds to step S330. Otherwise (NO in step S329), the processing proceeds to step S393.

In step S330, the system control unit 50 changes the setting of whether to incorporate the day data in the time information with its provenance to be assured and stores the changed setting in the memory 32.

In step S393, the system control unit 50 determines whether the user issues an instruction to return the screen from the detail setting screen (screen in FIG. 5D) for the time information to the screen (screen in FIG. 5A) for selecting the provenance assurance target data. The user can input the instruction to return the screen from the detail setting screen for the time information to the screen for selecting the provenance assurance target data by selecting, for example, a “Return” button as shown in FIG. 5D. In a case where the system control unit 50 determines that the instruction to return the screen to the screen for selecting the provenance assurance target data is not received (NO in step S393), the processing returns to step S325. In a case where the system control unit 50 determines that the instruction to return the screen to the screen for selecting the provenance assurance target data is received (YES in step S393), the processing proceeds to step S331.

In step S331, the system control unit 50 determines whether the user issues a setting change instruction of whether to incorporate information related to a photographer (hereinbelow, referred to as photographer related information) in the provenance assurance target. In a case where the user issues the setting change instruction of whether to incorporate the photographer related information in the provenance assurance target (YES in step S331), the processing proceeds to step S332. Otherwise (NO in step S331), the processing proceeds to step S333.

In step S332, the system control unit 50 changes the setting of whether to incorporate the photographer related information in the provenance assurance target and stores the changed setting in the memory 32.

In step S333, the system control unit 50 determines whether the user issues a change instruction to display a detail setting screen for the photographer related information with its provenance to be assured. The user can perform an operation on the menu screen to input the change instruction for displaying the detail setting screen for the photographer related information with its provenance to be assured. In the example of FIG. 5A, the “Detail 1” button 501 is displayed. In a case where the user selects the “Detail 1” button 501 in a state where a photographer item (item labeled “Photographer”) is the focus of the setting processing, the system control unit 50 determines that the change instruction for displaying the detailed setting screen for the photographer related information with its provenance to be assured is received. In a case where the user issues the change instruction for displaying the detail setting screen for the photographer related information with its provenance to be assured (YES in step S333), the system control unit 50 displays, for example, the screen in FIG. 5E, and the processing proceeds to step S334. Otherwise (NO in step S333), the processing proceeds to step S342.

In step S334, the system control unit 50 determines whether the user issues a setting change instruction of whether to incorporate a photographer's name data in the photographer related information with its provenance to be assured. In a case where the user issues the setting change instruction of whether to incorporate the photographer's name data in the photographer related information with its provenance to be assured (YES in step S334), the processing proceeds to step S335. Otherwise (NO in step S334), the processing proceeds to step S336.

In step S335, the system control unit 50 changes the setting of whether to incorporate the photographer's name data in the photographer related information with its provenance to be assured and stores the changed setting in the memory 32. In this case, it is assumed that ON and OFF are switched, but the user may explicitly designate ON or OFF.

In step S336, the system control unit 50 determines whether the user issues a setting change instruction of whether to incorporate a copyright holder's name data in the photographer related information with its provenance to be assured.

In a case where the user issues the setting change instruction of whether to incorporate the copyright holder's name data in the photographer related information with its provenance to be assured (YES in step S336), the processing proceeds to step S337. Otherwise (NO in step S336), the processing proceeds to step S338.

In step S337, the system control unit 50 changes the setting of whether to incorporate the copyright holder's name data in the photographer related information with its provenance to be assured and stores the changed setting in the memory 32.

In step S338, the system control unit 50 determines whether the user issues a setting change instruction of whether to incorporate a camera owner's name data in the photographer related information with its provenance to be assured. In a case where the user issues the setting change instruction of whether to incorporate the camera owner's name data in the photographer related information with its provenance to be assured (YES in step S338), the processing proceeds to step S339. Otherwise (NO in step S338), the processing proceeds to step S340.

In step S339, the system control unit 50 changes the setting of whether to incorporate the camera owner's name data in the photographer related information with its provenance to be assured and stores the changed setting in the memory 32.

In step S340, the system control unit 50 determines whether the user issues a setting change instruction of whether to incorporate a camera individual number (such as a camera serial number) data in the photographer related information with its provenance to be assured. In a case where the user issues the setting change instruction of whether to incorporate the camera individual number data in the photographer related information with its provenance to be assured (YES in step S340), the processing proceeds to step S341. Otherwise (NO in step S340), the processing proceeds to step S394.

In step S341, the system control unit 50 changes the setting of whether to incorporate the camera individual number data in the photographer related information with its provenance to be assured and stores the changed setting in the memory 32.

In step S394, the system control unit 50 determines whether the user issues an instruction to return the screen from the detail setting screen (screen in FIG. 5E) for the photographer related information to the screen (screen in FIG. 5A) for selecting the provenance assurance target data. The user can input the instruction to return the screen from the detail setting screen for the photographer related information to the screen for selecting the provenance assurance target data by selecting, for example, a “Return” button as shown in FIG. 5E. In a case where the system control unit 50 determines that the instruction to return the screen to the screen for selecting the provenance assurance target data is not received (NO in step S394), the processing returns to step S334. In a case where the system control unit 50 determines that the instruction to return to the screen for selecting the provenance assurance target data is received (YES in step S394), the processing proceeds to step S342.

In step S342, the system control unit 50 determines whether the user issues a setting change instruction of whether to incorporate information other than the location, the time, and the photographer in the provenance assurance target. In a case where the user issues the setting change instruction of whether to incorporate the information other than the location, the time, and the photographer in the provenance assurance target (YES in step S342), the processing proceeds to step S343. Otherwise (NO in step S342), the processing proceeds to step S344.

In step S343, the system control unit 50 changes the setting of whether to incorporate the information other than the location, the time, and the photographer in the provenance assurance target and stores the changed setting in the memory 32.

In step S344, the system control unit 50 determines whether the user issues an instruction to end the setting processing by operating the power switch 72 or the like. In a case where the user issues the instruction to end the setting processing (YES in step S344), the setting processing ends. Otherwise (NO in step S344), the processing returns to step S301.

As described above, the data about the location, the time, the photographer, and the other information to be incorporated in the provenance assurance target can be changed on the setting screens illustrated in FIGS. 5A to 5E.

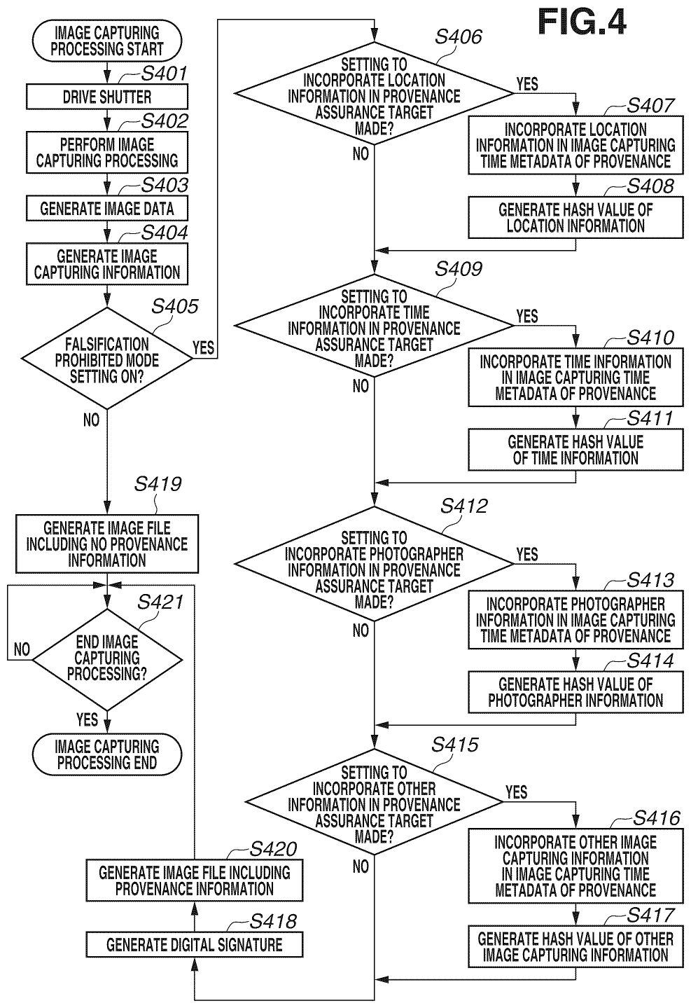

With the processing described above, the settings concerning the provenance assurance target are configured. In the present exemplary embodiment, the image capturing processing is performed after configuring these settings. The image capturing processing performed in step S004 of FIG. 3A will be described. FIG. 4 is a flowchart illustrating the image capturing processing according to the present exemplary embodiment.

The image capturing processing starts when an image capturing start operation, such as the shutter button 61 being pressed, or the like, is received.

In step S401, the system control unit 50 drives the shutter 101 arranged on the object side of the image capturing unit 22 to control an exposure time.

In step S402, the system control unit 50 performs image capturing processing of converting light received by the image capturing unit 22 from an object via the shutter 101 into an electrical signal (analog image data).

In step S403, the system control unit 50 performs image processing, such as development processing, coding processing, or the like, on the electrical signal obtained by the image capturing processing described above to generate image data.

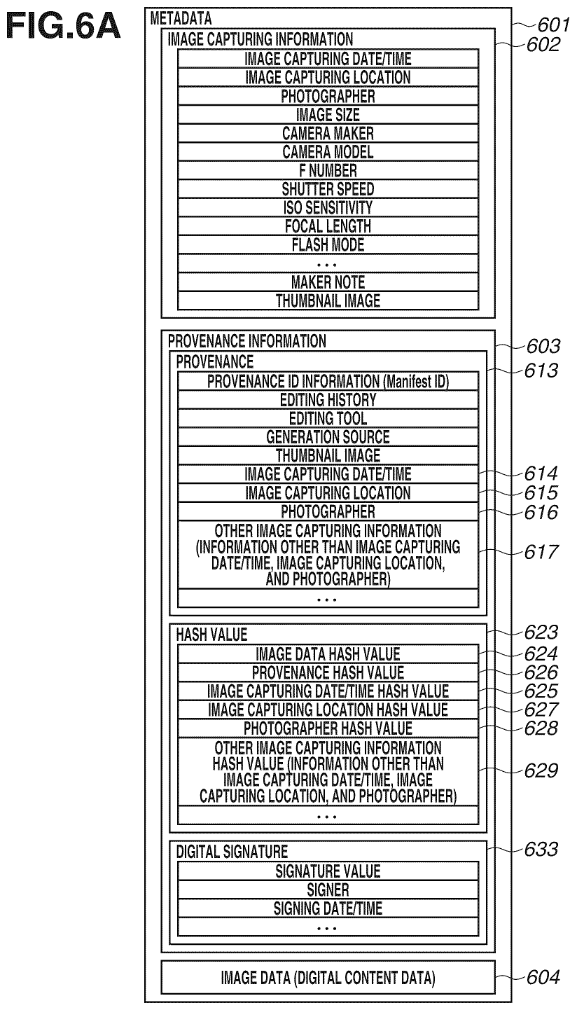

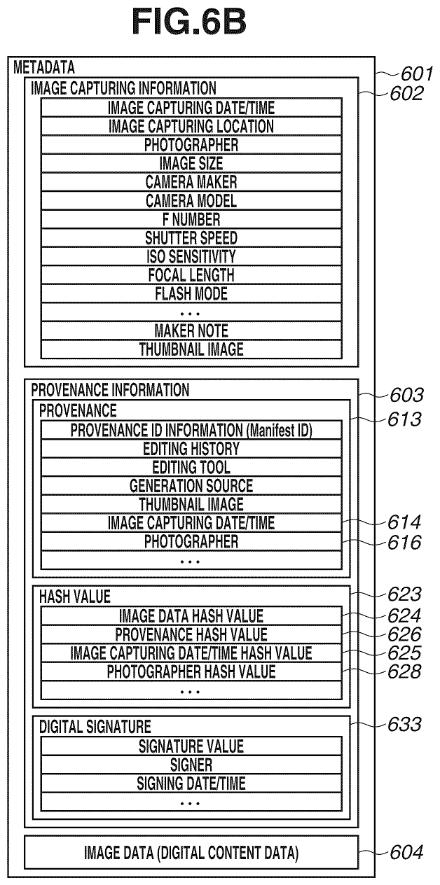

In step S404, the system control unit 50 generates metadata 601 including image capturing information 602 of the image data 604 as illustrated in FIG. 6A. The image capturing information 602 is information obtained when the image capturing processing for generating the image data 604 is performed, and includes, for example, an image capturing date/time, a photographer, an image size, a maker or a model type of the image capturing apparatus, and various kinds of image capturing parameters set at the image capturing time, an image capturing location, a thumbnail image, and so on. The image capturing information 602 is generated in compliance with a predetermined technical standard, for example, Exchangeable image file format (EXIF).

In step S405, the system control unit 50 determines whether the falsification prohibited mode is ON. In a case where the system control unit 50 determines that the falsification prohibited mode is ON (YES in step S405), the processing proceeds to step S406. Otherwise (NO in step S405), the processing proceeds to step S419.

In step S406, the system control unit 50 determines whether the setting to incorporate the location information in the provenance assurance target is active (i.e., checked). The setting to incorporate the location information in the provenance assurance target is a setting identified by the processing of the flowchart in FIGS. 3B1 and 3B2. In a case where the system control unit 50 determines that the setting to incorporate the location information in the provenance assurance target is active (YES in step S406), the processing proceeds to step S407. Otherwise (NO in step S406), the processing proceeds to step S409 without performing the processing in steps S407 and S408.

In step S407, the system control unit 50 incorporates location information 615 at the image capturing time in provenance 613 described below. The location information to be incorporated in the metadata 601 is, for example, checked location items among the above-described latitude, longitude, altitude, UTC, country, and region. Unchecked location items are not incorporated.

In step S408, the system control unit 50 generates a hash value from the location information included in the image capturing information 602 and incorporates the generated hash value in a hash value 623 as an image capturing location hash value 627.

The provenance information 603 is information for proving the authenticity of the image data 604 and is used to verify the source and the provenance of the image data 604. The provenance information 603 is generated in compliance with a predetermined technical standard (e.g., Coalition for Content Provenance and Authenticity (C2PA)) and has a specified structure.

The provenance information 603 includes the provenance 613, the hash value 623, and a digital signature 633 for assuring the provenance 613. The provenance is equivalent to Assertion in a C2PA format. Provenance identification information (Manifest ID) for uniquely identifying the provenance, an editing history indicating the edited contents of the image data 604, an editing tool indicating a tool used for the editing, and a creator of the image data 604 are stored in the provenance 613. As the image data 604 generated in step S403 is just generated by the image capturing and not edited yet, information indicating “generated” is stored in the editing history, and information indicating the image capturing apparatus is stored in the editing tool.

In a case where the location information is included in the provenance assurance target, image capturing location data included in the image capturing information 602 can be verified by the image capturing location hash value 627. For verification, an apparatus used for the verification should be enabled to understand which hash value included in the hash value 623 is for which attribute's hash value. Thus, to recognize each hash value, each hash value should be named so that it may be understand that the hash value is a hash value of the image capturing date/time, or the image capturing location, and so on. When the verification of the image capturing date/time is performed, for example, it is only necessary to compare the hash value calculated from the image capturing date/time recorded in the metadata of the image data and an image capturing date/time hash value 625 recorded in the image data to determine whether the two values match each other. If the two values do not match each other, it can be determined that editing has been performed on the image data, and the image data is not an original. The hash values of other attributes can be similarly verified.

In a case where the location information is excluded from the provenance assurance target, as illustrated in FIG. 6B, for example, an image capturing location 615 is not included in the provenance 613 and the image capturing location included in the image capturing information 602 is not assured by the image capturing location hash value 627. Since the provenance 613 in FIG. 6B does not include the location information, the provenance hash value 626 in FIG. 6A and the provenance hash value 626 in FIG. 6B have values different from each other.

By preparing a hash value for each piece of metadata, it is possible to assure the authenticity of the image capturing date/time, and the photographer, even if the location information is edited later.

In step S409, the system control unit 50 determines whether the setting to incorporate the time information in the provenance assurance target is active. In a case where the system control unit 50 determines that the setting to incorporate the time information in the provenance assurance target is active (YES in step S409), the processing proceeds to step S410. Otherwise (NO in step S409), the processing proceeds to step S412.

In step S410, the system control unit 50 incorporates an image capturing date/time 614 in the provenance 613 as metadata. The time information to be incorporated is, for example, time items checked in advance among the year, the month, and the day as described above.

In step S411, the system control unit 50 generates a hash value from the image capturing date/time information included in the image capturing information 602 and incorporates the generated hash value in the hash value 623 as an image capturing date/time hash value 625.

In step S412, the system control unit 50 determines whether the setting to incorporate the photographer information in the provenance assurance target is active. In a case where the system control unit 50 determines that the setting to incorporate the photographer information in the provenance assurance target is active (YES in step S412), the processing proceeds to step S413. Otherwise (NO in step S412), the processing proceeds to step S415.

In step S413, the system control unit 50 incorporates a photographer 616 at the image capturing time in the provenance 613 as metadata. The photographer information to be incorporated is, for example, photographer items checked in advance among the photographer's name, the copyright holder's name, the camera owner's name, and the camera individual number as described above.

In step S414, the system control unit 50 generates a hash value from the photographer included in the image capturing information 602 and incorporates the generated hash value in the hash value 623 as a photographer hash value 628.

In step S415, the system control unit 50 determines whether the setting to incorporate the information other than the location, the time, and the photographer in the provenance assurance target is active. In a case where the system control unit 50 determines that the setting to incorporate the information other than the location, the time, and the photographer in the provenance assurance target is active (YES in step S415), the processing proceeds to step S416. Otherwise (NO in step S415), the processing proceeds to step S418.

In step S416, the system control unit 50 incorporates other information 617 other than the location, the time, and the photographer in the provenance 613 as metadata. The other information to be incorporated is, for example, an International Organization for Standardization (ISO) sensitivity, a focal length, an AF setting, a white balance (WB) setting, and so on.

In step S417, the system control unit 50 generates a hash value from the information other than the image capturing location, the image capturing date/time, and the photographer included in the image capturing information 602 and incorporates the generated hash value in the hash value 623 as a hash value 629 of the other image capturing information.

In step S418, the system control unit 50 generates the digital signature 633. The digital signature 633 includes information indicating a signature value, a signer, and a signing date/time. The signature value is generated by encrypting the generated hash value 623 using a secret key prepared in advance. A public key paired with the used secret key is also stored in the digital signature 633. To prove that the public key is published from a reliable maker, the digital signature 633 may store information indicating a maker of the image capturing apparatus as a signer or a public key certificate indicating that the public key is authenticated by a certificate authority. By adding the digital signature 633 including a signer to an image file, it is possible to indicate that the image file is reliable. Instead of the maker, the model type of the image capturing apparatus may be used as the signer. The signing date/time is a date and time at which the generation of the digital signature is completed.

In step S419, the system control unit 50 adds the image capturing information 602 to the image data 604 as the metadata 601, excluding the provenance information 603, and generates the image file. The image file is generated in compliance with a Joint Photographic Experts Group (JPEG) format in a case where the image data 604 is a still image and is generated in compliance with a Moving Picture Experts Group (MPEG) format in a case where the image data 604 is a moving image.

In step S420, the system control unit 50 adds the image capturing information 602 and the provenance information 603 to the image data 604 as the metadata 601 and generates the image file. The hash value 623 is generated by executing the hash function on the binary data required for each of the image data 604 and the provenance 613. A hash value of the binary data of the provenance 613 may be generated for each smaller unit, such as an editing history, a generation source, or the like, to detect falsification in smaller units, and it is also possible to verify data of a unit designated by the user according to the present exemplary embodiment. The image file is generated in compliance with the JPEG format in a case of a still image and in compliance with the MPEG format in a case of a moving image.

In step S421, the system control unit 50 determines whether the user issues an instruction to end the image capturing processing. In a case where the system control unit 50 determines that the user issues the instruction to end the image capturing processing (YES in step S421), the system control unit 50 ends the image capturing processing. Otherwise (NO in step S421), the processing in step S421 is repeated.

As described above, in the present exemplary embodiment, when the image capturing apparatus performs image capturing, an image file is generated.

The image file may sometimes be edited using an application program. When the image file is edited using a licensed editing tool according to a correct procedure, the provenance information 603 is newly generated in accordance with a predetermined technical standard based on the edited content, and the generated provenance information 603 is additionally stored in the metadata 601 of the image file. The provenance information 603 is newly generated each time the image file is edited, and additionally stored in the metadata 601 of the image file. On the other hand, in a case where the editing of the image file is performed using a non-licensed editing tool or according to an incorrect procedure, it is possible that the provenance information 603 may not be added to the image file, or the provenance added to the image file may not comply with the predetermined technical standard.

In the present exemplary embodiment, it is possible to detect the falsification of the image file by generating the hash value and the signature value. For example, the hash value is generated by executing the hash function on the binary data of the image data 604 of the image file. The generated hash value is compared with an image data hash value 624 of the image file serving as a determination target. In this way, the presence/absence of the falsification of the image data can be verified. In a similar manner, a hash value is generated by executing the hash function on the binary data of the image capturing information 602 of the image file. The generated hash value is compared with a hash value of each piece of the image capturing information of the image file serving as a determination target. In this way, it is possible to verify the presence/absence of the falsification of the image capturing date/time, the image capturing location, the photographer, and the other data. As described above according to the present exemplary embodiment, it is possible to set only the selected data as the provenance assurance target, and the technique is applicable to an editing application installed in a smartphone, a personal computer, or the like, in addition to the image capturing apparatus.

Further, a hash value is generated by executing the hash function on the binary data of the provenance 613. The generated hash value is compared with the provenance hash value 626 of the image file serving as a determination target. In this way, the presence/absence of the falsification of the provenance data can be verified. The binary data may be compared in a smaller unit such as an editing history, a generation source, thumbnail data, metadata, and so on. The signature value can be decrypted by the public key, and it is possible to determine that the signature value is successfully verified when the hash values match each other. In this way, the mechanism to detect the falsification can be built in the image file.

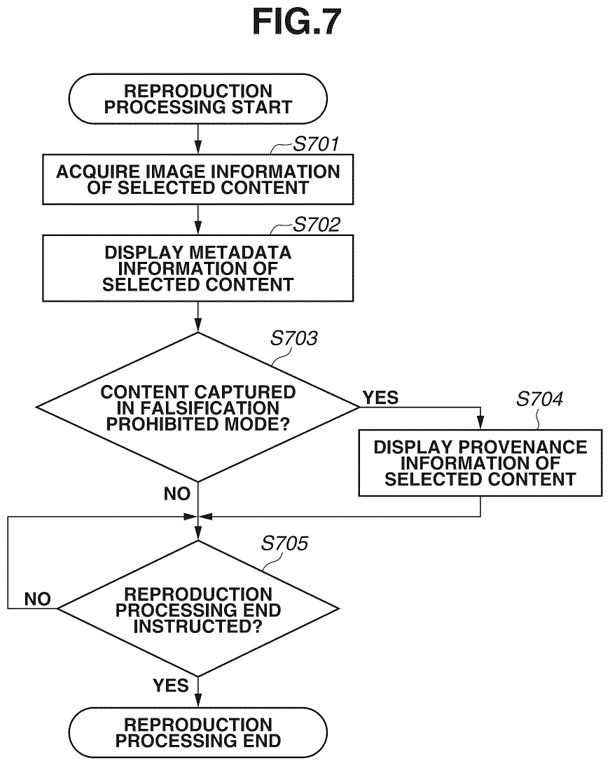

The reproduction processing performed in step S006 in FIG. 3A will be described. FIG. 7 is a flowchart illustrating the reproduction processing according to the present exemplary embodiment.

The reproduction processing starts when a reproduction start operation such as a press of the reproduction button 79, or the like, is received.

In step S701, the system control unit 50 acquires image information of selected content. The image information includes image data (main image/thumbnail) and metadata such as a color gamut and a gamma characteristic when the image is captured.

In step S702, the system control unit 50 displays the metadata of the selected content on the display unit 28.

In step S703, the system control unit 50 determines whether the content was captured in the falsification prohibited mode. In a case where the content was captured in the falsification prohibited mode (YES in step S703), the processing proceeds to step S704. Otherwise (NO in step S703), the processing proceeds to step S705. The determination may be made by checking whether the image file is in compliance with the C2PA format. Alternatively, the determination may be made by recording information indicating that the image was captured in the falsification prohibited mode in the maker note in EXIF when the image file generated in steps S419 or S420 is generated, and referring to the information.

In step S704, the system control unit 50 displays the provenance information of the selected content on the display unit 28. The information to be displayed is assumed to be provenance assured data, and in a case where there is data the user has excluded from the provenance assurance target, the information indicating the excluded data is not displayed. Alternatively, even if the excluded data is displayed, the excluded data may be displayed in a discriminable manner from the information in the assurance target, so as to indicate that the data is excluded from the provenance assurance target.

In step S705, the system control unit 50 determines whether the user issues an instruction to end the reproduction processing. In a case where the system control unit 50 determines that the user issues the instruction to end the reproduction processing (YES in step S705), the system control unit 50 ends the reproduction processing. Otherwise (NO in step S705), the processing in step S705 is repeated.

As describe above, in the present exemplary embodiment, when the image capturing apparatus performs the reproduction processing, the image file is reproduced, and which data is provenance assured can be checked.

Embodiments of the present disclosure can be realized by executing the following processing. Specifically, software (program) to realize the exemplary embodiments described above is supplied to a system or an apparatus via a network or various kinds of storage media, and a computer (central processing unit (CPU) or micro-processing unit (MPU)) of the system or the apparatus reads and executes the program code. In this case, the program and the recording medium storing the program constitute an embodiment of the present disclosure. Embodiments of the present disclosure can also be realized by a circuit (e.g., application specific integrated circuit (ASIC)) that can implement one or more functions.

### Disclosure of Present Specification

The present disclosure includes an image processing apparatus, an image processing method, a system, and a storage medium.

### Item 1

An electronic apparatus comprising at least one memory storing one or more programs, and at least one processor that, upon execution of the stored one or more programs, causes the at least one processor to generate content including a plurality of metadata items, select one or more metadata items from among the plurality of metadata items to be incorporated in provenance data, and generate the provenance data that incorporates the selected one or more metadata items and a hash value wherein the provenance data is generated when the content including the plurality of metadata items is generated.

### Item 2

The electronic apparatus according to Item 1, wherein a digital signature is generated from the hash value, and the generated digital signature is incorporated in the provenance data.

### Item 3

The electronic apparatus according to Item 1, wherein the selectable one or more metadata items from among the plurality of metadata items includes time information.

### Item 4

The electronic apparatus according to Item 3, wherein the time information includes one or more of year information, month information, or day information.

### Item 5

The electronic apparatus according to Item 1, wherein the selectable one or more metadata items from among the plurality of metadata items includes location information.

### Item 6

The electronic apparatus according to Item 5, wherein the location information includes one or more of latitude information, longitude information, altitude information, or Universal Time Coordinated (UTC) information.

### Item 7

The electronic apparatus according to Item 5, wherein the location information includes information regarding a region.

### Item 8

The electronic apparatus according to Item 1, wherein the selectable one or more metadata items from among the plurality of metadata items includes information identifying a photographer.

### Item 9

The electronic apparatus according to Item 8, wherein the information identifying the photographer includes one or more of a photographer's name, a copyright holder's name, an owner's name of the electronic apparatus, or an individual number of the electronic apparatus.

### Item 10

The electronic apparatus according to Item 1, wherein location information, time information, and information identifying the photographer are excluded from the one or more metadata items from among the plurality of metadata items that can be selected to be incorporated in the provenance data.

### Item 11

The electronic apparatus according to Item 1, wherein the provenance data that incorporates the selected one or more metadata items and the hash value can be displayed on a screen on which the content is reproduced.

### Item 12

The electronic apparatus according to Item 1, wherein all items are targets to be incorporated in the provenance data, before the item is selected by the selection unit.

### Item 13

A method of controlling an electronic apparatus, comprising generating content including a plurality of metadata items, selecting one or more metadata items from among the plurality of metadata items to be incorporated in provenance data, and generating provenance data that incorporates the selected one or more metadata items and a hash value, wherein the provenance data is generated when the content including the plurality of metadata items is generated.

### Item 14

A non-transitory computer-readable storage medium storing a program for causing a computer to function as the units in the electronic apparatus according to Item 1.

According to the present disclosure, it is possible to both prevent leaving unnecessary metadata and appropriately assure authenticity of the necessary metadata. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-082458, filed May 21, 2024, the entirety of which is incorporated herein by reference.

1. An electronic apparatus comprising:
at least one memory storing one or more programs; and
at least one processor that, upon execution of the stored one or more programs, causes the at least one processor to:
generate content including a plurality of metadata items;
select one or more metadata items from among the plurality of metadata items to be incorporated in provenance data; and
generate the provenance data that incorporates the selected one or more metadata items and a hash value wherein the provenance data is generated when the content including the plurality of metadata items is generated.

2. The electronic apparatus according to claim 1, wherein a digital signature is generated from the hash value, and the generated digital signature is incorporated in the provenance data.

3. The electronic apparatus according to claim 1, wherein the selectable one or more metadata items from among the plurality of metadata items includes time information.

4. The electronic apparatus according to claim 3, wherein the time information includes one or more of year information, month information, or day information.

5. The electronic apparatus according to claim 1, wherein the selectable one or more metadata items from among the plurality of metadata items includes location information.

6. The electronic apparatus according to claim 5, wherein the location information includes one or more of latitude information, longitude information, altitude information, or Universal Time Coordinated (UTC) information.

7. The electronic apparatus according to claim 5, wherein the location information includes information regarding a region.

8. The electronic apparatus according to claim 1, wherein the selectable one or more metadata items from among the plurality of metadata items includes information identifying a photographer.

9. The electronic apparatus according to claim 8, wherein the information identifying the photographer includes one or more of a photographer's name, a copyright holder's name, an owner's name of the electronic apparatus, or an individual number of the electronic apparatus.

10. The electronic apparatus according to claim 1, wherein location information, time information, and information identifying the photographer are excluded from the one or more metadata items from among the plurality of metadata items that can be selected to be incorporated in the provenance data.

11. The electronic apparatus according to claim 1, wherein the provenance data that incorporates the selected one or more metadata items and the hash value can be displayed on a screen on which the content is reproduced.

12. The electronic apparatus according to claim 1, wherein all metadata items from among the plurality of metadata items are selected to be incorporated in the provenance data.

13. A method of controlling an electronic apparatus, comprising:
generating content including a plurality of metadata items;
selecting one or more metadata items from among the plurality of metadata items to be incorporated in provenance data; and
generating provenance data that incorporates the selected one or more metadata items and a hash value, wherein the provenance data is generated when the content including the plurality of metadata items is generated.

14. A non-transitory computer-readable storage medium storing a program for causing a computer to execute a method of controlling an electronic apparatus, the method comprising the steps of:
generating content including a plurality of metadata items;
selecting one or more metadata items from among the plurality of metadata items to be incorporated in provenance data; and
generating provenance data that incorporates the selected one or more metadata items and a hash value, wherein the provenance data is generated when the content including the plurality of metadata items is generated.
